(19) United States
(12) Patent Application Publication
(10) Pub. No.: US 2016/0093956 A1
(43) Pub. Date: Mar. 31, 2016

(54) RADAR APPARATUS

(71) Applicant: NIDEC ELESYS CORPORATION, Kawasaki-shi (JP)

(72) Inventor: Akira ABE, Kawasaki-shi (JP)

(21) Appl. No.: 14/862,459

(22) Filed: Sep. 23, 2015

(30) Foreign Application Priority Data
Sep. 30, 2014 (JP) 2014-202040
Sep. 16, 2015 (JP) 2015-183188

(51) Int. Cl. H01Q 13/02

(52) U.S. Cl. CPC H01Q 13/0233; G01S 2007/027

(57) ABSTRACT

A radar apparatus of the present invention includes an antenna member capable of emitting or receiving microwaves; a feed unit including a plurality of waveguides each having one end connected to a base portion of the antenna member; a radio frequency circuit in contact with the feed unit; an information-processing circuit; a signal line connecting the radio frequency circuit and the information-processing circuit; and a common board equipped with the radio frequency circuit and the information-processing circuit. Since planar positions of the information-processing circuit and the radio frequency circuit on the common board do not overlap with each other, it is possible to downsize the radar apparatus. The common board includes a closed foil made of conductive material and surrounding the radio frequency circuit, and the closed foil made of conductive material is grounded.

### BACKGROUND OF THE INVENTION

1. Field of the Invention

The present invention relates to a radar apparatus.

2. Description of the Related Art

In recent years, radar apparatuses have rapidly spread that are used as sensor equipment for use in the collision mitigation and anti-collision control for commercially-available automobiles. For future advanced safety functions, there are needs for the protection for two-wheel vehicle riders and pedestrians and driver assistance (driver support) with respect to invisible areas, in addition to conventionally-developed automatic steering functions for vehicles. Diversified functions of automotive safety devices now entail widening of view angles, increase in the detection distance, and improvement for the rate of recognition of objects to be detected.

Meanwhile, the modularization of radar apparatuses is being promoted in view of flexibility in installation, appearance, and possibility of coexistence with camera sensor equipment. For example, United States Unexamined Patent Application Publication No. 2011/0163904 A1 proposes a method in which a composite apparatus composed of a radar apparatus and a camera sensor is provided in an upper section of a windshield inside a vehicle compartment.

The radar apparatus, if required to have multiple functions and to be functionally upgraded as described above, may suffer from a problem of cost increase.

### SUMMARY OF THE INVENTION

An object of the present invention, which has been accomplished in view of the above-described points of discussion, is to provide a radar apparatus with a lower production cost.

In order to achieve the above-described object, a radar apparatus according to one preferable preferred embodiment of the present invention includes: an antenna member capable of emitting or receiving microwaves; a feed unit including a plurality of waveguides having one end connected to a base portion of the antenna member; a radio frequency circuit in contact with the feed unit; an information-processing circuit; a signal line connecting the radio frequency circuit and the information-processing circuit; and a common board equipped with the radio frequency circuit and the information-processing circuit, wherein planar positions of the information-processing circuit and the radio frequency circuit on the common board do not overlap with each other, the common board includes a closed foil made of a conductive material and surrounding the radio frequency circuit, and the closed foil made of conductive material is grounded.

According to one preferable preferred embodiment in accordance with the present invention, it is possible to obtain a radar apparatus with a lower production cost.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a perspective view illustrating the external configuration of a radar apparatus of one preferred embodiment.

FIG. 2 illustrates a schematic cross-sectional view of the radar apparatus of one preferred embodiment.

FIG. 3 shows a perspective view illustrating a state of an antenna member and a feed member before assembly in the radar apparatus of one preferred embodiment.

FIG. 4 shows a perspective view illustrating a state after the feed member is assembled into the antenna member in the radar apparatus of one preferred embodiment.

FIG. 5 illustrates a plan view when a radar control board is viewed from the lower surface side thereof in the radar apparatus of one preferred embodiment.

FIG. 6 shows a perspective view illustrating a state of the radar apparatus in which an upper case and a front cover are removed in the radar apparatus of one preferred embodiment.

FIG. 7 shows a perspective view illustrating the external configuration of a radar apparatus of a variation.

### DETAILED DESCRIPTION OF THE PREFERRED EMBODIMENTS

Hereinafter, preferred embodiments will be described while referring to the accompanying drawings.

It should be noted that drawings may be illustrated with non-characterizing portions excluded.

An X-Y-Z coordinate system is shown in each drawing. In the following description, each direction will be discussed as necessary, according to each coordinate system.

The radar apparatus 100 of the present preferred embodiment is, for example, an apparatus for transmitting millimeter radar waves. The radar apparatus 100 is installed facing in the front direction of a vehicle, for example, to detect objects ahead of the vehicle.

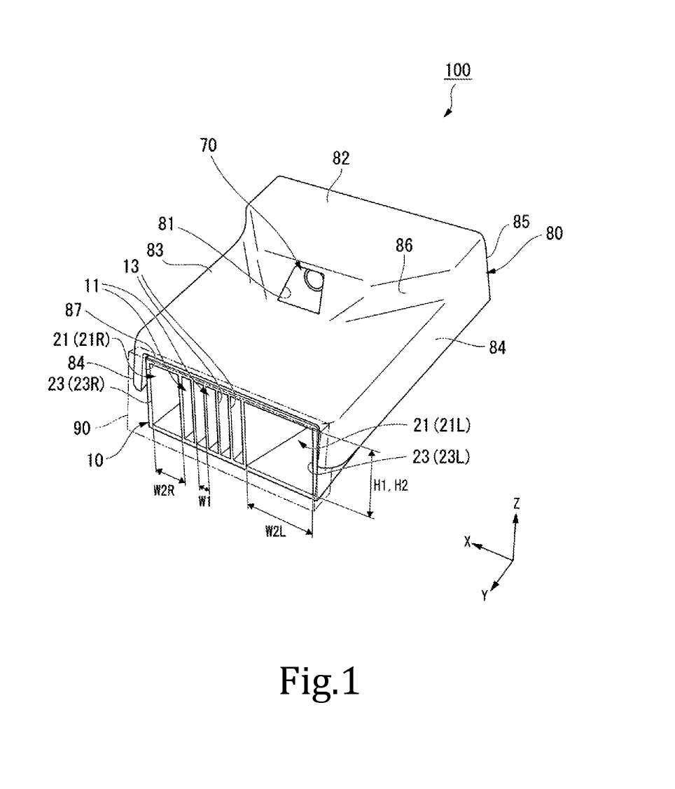

FIG. 1 shows a perspective view illustrating the external configuration of the radar apparatus 100 of the present preferred embodiment. Note that in FIG. 1, a front cover 90 is shown by a single-dot chain line for the sake of description of each constituent part.

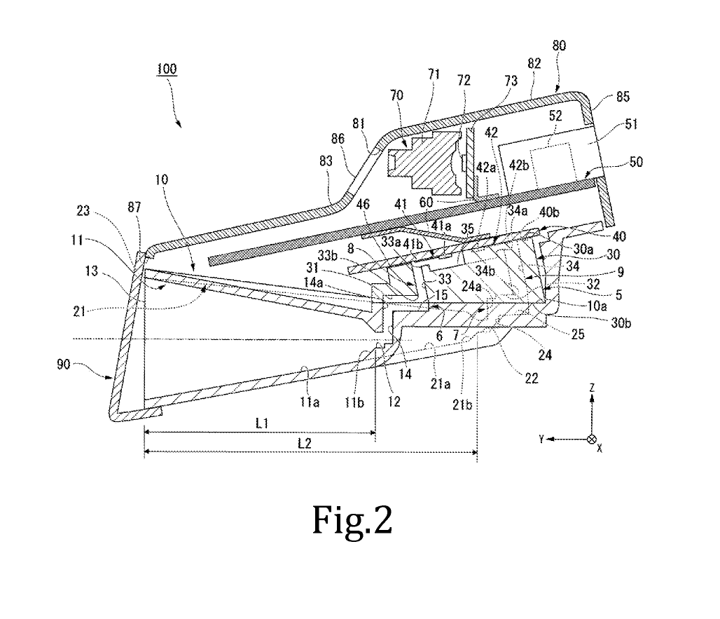

FIG. 2 illustrates a schematic cross-sectional view of the radar apparatus 100. Note that FIG. 2 shows a drawing schematically illustrated by, for example, partially enlarging the drawing to describe each constituent part. Also note that FIG. 2 illustrates a cross-sectional view taken by selecting, as appropriate, a cross-section along a proper plane passing through portions to be described, rather than a cross-section along a single plane, in order to show the portions in an easy-to-understand manner.

As illustrated in FIGS. 1 and 2, the radar apparatus 100 includes an antenna member 10; a feed member 30; a radar control board (common board) 40; a power-supply circuit board 50; an imaging apparatus 70; an upper case 80; and a front cover 90.

The antenna member 10 is provided with first-type horns 11 and second-type horns 21. The feed member 30 is fitted on an upper surface (antenna member-side contact surface) 10a of the antenna member 10. The radar control board (common board) 40 is fitted on the feed member 30 and on an upper surface 30a thereof. The power-supply circuit board 50 is located above the radar control board 40 and connected to the radar control board 40 using a wire 60. The imaging apparatus 70 is located above the power-supply circuit board 50. The upper case 80 covers the antenna member 10 from above, thus covering components disposed on the antenna member 10. The front cover 90 covers the front side of the antenna member 10.

The antenna member 10 and the feed member 30 constitute a feed unit 5. The feed unit 5 includes first-type waveguides 8 and second-type waveguides 9.

The radar apparatus 100 guides radar waves (radio frequency electromagnetic waves) output by a second-type radio frequency circuit 42 mounted on the radar control board 40 through the second-type waveguides 9 and transmits the waves from the second-type horns 21 of the antenna member 10. In addition, the radar apparatus 100 captures radar waves reflecting on a detection object with the first-type horns 11, guides the radar waves through the first-type waveguides 8, and receives the radar waves with a first-type radio frequency circuit 41 mounted on the radar control board 40.

Note that in the following description, a +Y direction and a −Y direction in FIG. 1 that are directions in which radar waves are transmitted by the antenna member 10 are defined as a forward direction and a backward direction, respectively. In addition, a +X direction, a −X direction, a +Z direction, and a −Z direction in FIG. 1 when the radar apparatus 100 is faced in the forward direction (+Y direction) are defined as a rightward direction, a leftward direction, an upward direction, and a downward direction, respectively.

Also note that each direction does not necessarily represent the direction of the radar apparatus 100 of the present preferred embodiment when the radar apparatus is mounted on a vehicle. Accordingly, for example, the radar apparatus 100 can be assembled into a vehicle with the apparatus turned upside down.

Hereinafter, constituent parts of the radar apparatus 100 will be described in detail.

As illustrated in FIG. 1, the antenna member 10 includes five first-type horns 11 lining up side by side in the width direction (X-axis direction) thereof and forming a row in the width direction; and two second-type horns 21 positioned at the leftmost and rightmost ends of the row of the first-type horns 11. All of the five first-type horns 11 and the two second-type horns 21 face in the same direction. That is, if a direction in which one of the first-type horns faces is defined as the forward direction, then other first-type horns 11 and second-type horns 21 also face the forward direction.

The antenna member 10 is preferably composed of, for example, aluminum alloy and manufactured by means of die-casting. The antenna member 10 can emit or receive microwaves including millimeter waves.

In general, a horn refers to a tubular member that widens toward the leading end thereof. In the present application, however, the term “horn” is used in a slightly different sense. Since what attention is paid to in the present invention is a hollow portion through which radio waves are guided, this hollow portion is referred to as the horn. Accordingly, if, for example, one block-shaped member includes three forward-widened cavities, the one member is considered to include three horns. Likewise, if three forward-widened tubes are bundled, the bundled member is considered to include three horns.

More particularly, a horn is a cavity extending from the base portion toward the aperture side thereof, where the cross-sectional area of the cavity in a plane perpendicular to the extension direction of the cavity continuously expands from the base portion toward the aperture. However, the horn may include a portion where the cross-sectional area is constant or decreases partially, as long as the portion has a length equal to or shorter than that of the wavelength of radio waves traveling through the horn.

Note that in the present preferred embodiment, pyramidal horns are used, in particular, as the first-type horns and the second-type horns 21. The aperture of a horn is expressed as an opening in some cases. In the present application, however, the expression “aperture” is used to refer to the radio emission port of the horn. The term “opening” will be used to describe a hole or cavity provided in members other than horns.

In a case where the direction in which a horn faces is described in the text or in claims, it refers to a direction in which the aperture is viewed from the base portion of the horn.

Each first-type horn 11 functions as part of an antenna for receiving radar waves.

As illustrated in FIG. 2, each first-type horn 11 is a pyramidal horn having a pyramidal shape in which the horn gradually widens from a base portion 12 to an aperture 13 thereof. The length from the base portion 12 to the aperture 13 of the first-type horn 11 is a first-type length L1. For ease of explanation, each portion of the first-type horns and second-type horns will be expressed as “first-type (name of portion)” or “second-type (name of portion),” as described above.

The respective apertures 13 of the five first-type horns 11 are disposed on the same plane in the longitudinal direction of the horns. Since the five first-type horns 11 have the same first-type length L1, the respective base portions 12 are also disposed on the same plane in the longitudinal direction of the horns.

As illustrated in FIG. 1, the apertures 13 of the five first-type horns 11 have the same shape. That is, the apertures of the five first-type horns 11 have the same first-type height H1. In addition, the apertures 13 of the five first-type horns 11 have the same first-type width W1. Each aperture 13 has a vertically long rectangular transverse cross-sectional shape in which the first-type height H1 is greater than the first-type width W1.

The five first-type horns 11 are disposed in the width direction thereof, so as to be mutually complementary, thereby enhancing the performance of radar wave reception. Note that the number of first-type horns 11 is not limited to five, but may be one or more than one. The number of first-type horns is preferably equal to or greater than three. This quantity makes it possible to ensure reception performance. In addition, since the first-type horns 11 are disposed side by side in the width direction, it is possible to reduce the height dimension of the radar apparatus 100 as a whole.

Each second-type horn 21 functions as part of an antenna for transmitting radar waves.

As illustrated in FIG. 1, the second-type horns 21 are positioned on the left and right of a row of the first-type horns 11. When the second-type horns 21 are described by distinguishing between the horns positioned on the left and right, the horn positioned on the right-hand side (+X side) of the row of the first-type horns 11 is referred to as a rightmost horn 21R, whereas the horn positioned on the left-hand side (−X side) is referred to as a leftmost horn 21L.

As illustrated in FIG. 2, each second-type horn 21 is a pyramidal horn having a pyramidal shape in which the horn gradually widens from a base portion 22 to an aperture 23 thereof. The length from the base portion 22 to the aperture 23 of the second-type horn 21 is expressed as a second-type length L2. Note that the rightmost horn 21R and the leftmost horn 21L may differ in length. The second-type horns 21 are described here, however, assuming that the horns have the same second-type length L2.

The second-type length L2 of the second-type horns 21 is greater than the first-type length L1 of the first-type horns 11. In other words, both of the second-type horns 21 are longer than the first-type horns 11.

As illustrated in FIG. 1, the aperture 23R of the rightmost horn 21R and the aperture 23L of the leftmost horn 21L have the same second-type height H2. In addition, the second-type height H2 is the same as the first-type height H1.

A width W2R of the aperture 23R of the rightmost horn 21R is smaller than a width W2L of the aperture 23L of the leftmost horn 21L. The aperture 23R of the rightmost horn 21R has a vertically long rectangular transverse cross-sectional shape whose height H2 is greater than the width W2R. On the other hand, the aperture 23L of the leftmost horn 21L has a transverse cross-sectional shape close to a square whose height H2 is substantially the same as the width W2L.

The orientation of the rightmost horn 21R and the orientation of the leftmost horn 21L may differ in elevation and depression angles (or elevation angle or depression angle) from each other. For example, the orientation of the rightmost horn 21R may be directed more downward than the orientation of the leftmost horn 21L. In this case, the rightmost horn 21R emits radar waves toward objects located on places of a road relatively close to a vehicle mounted with the radar apparatus 100 to detect the objects. On the other hand, the leftmost horn 21L detects objects located on places of the road distant from the vehicle, relatively tall objects and the like.

The apertures 23 of the two second-type horns 21 are disposed on the same plane in the longitudinal direction of the horns.

Likewise, in the present preferred embodiment, the apertures 23 of the second-type horns 21 and the apertures 13 of the first-type horns 11 are disposed on the same plane in the longitudinal direction of the horns. In addition, even if the apertures 13 of the first-type horns 11 and the apertures 23 of the second-type horns 21 are not on the same plane, the positional difference between the apertures 13 and 23 in the longitudinal direction is preferably smaller than the free space wavelength of a radar wave (radio frequency electromagnetic wave) output by the second-type radio frequency circuit 42. This configuration prevents radar waves received by the first-type horns 11 from being disturbed by the apertures 23 of the second-type horns 21. Alternatively, this configuration prevents radar waves transmitted from the second-type horns 21 from being disturbed by the apertures 13 of the first-type horns 11.

Yet additionally, the base portions 22 of the second-type horns 21 are preferably positioned more backward than the base portions 12 of the first-type horns 11 by as much as a distance greater than the free space wavelength of a radio frequency wave output by the second-type radio frequency circuit 42. This configuration allows the second-type horns 21 to be elongated to such an extent that the directionality of the second-type horns 21 as antennas is higher than the directionality of the first-type horns 11 as antennas.

As illustrated in FIG. 2, first-type lower holes 14 extending vertically upward with respect to the orientation of the first-type horns 11 from the respective base portions 12 of the first-type horns 11 are provided in the antenna member 10. Five first-type lower holes 14 are provided in respective correspondence with the five first-type horns 11. The first-type lower holes 14 constitute openings 14a on the upper surface (antenna member-side contact surface) 10a of the antenna member 10.

Likewise, second-type lower holes 24 extending vertically upward with respect to the orientation of the second-type horns 21 from the base portions 22 of the second-type horns 21 are provided in the antenna member 10. Two second-type lower holes 24 are provided in respective correspondence with the two second-type horns 21. The second-type lower holes 24 constitute openings 14a on the upper surface 10a of the antenna member 10.

The upper surface 10a of the antenna member 10 is substantially parallel to the width and length directions of the first-type horns 11 and the second-type horns 21. In addition, the upper surface 10a is substantially vertical to the first-type lower holes 14 and the second-type lower holes 24.

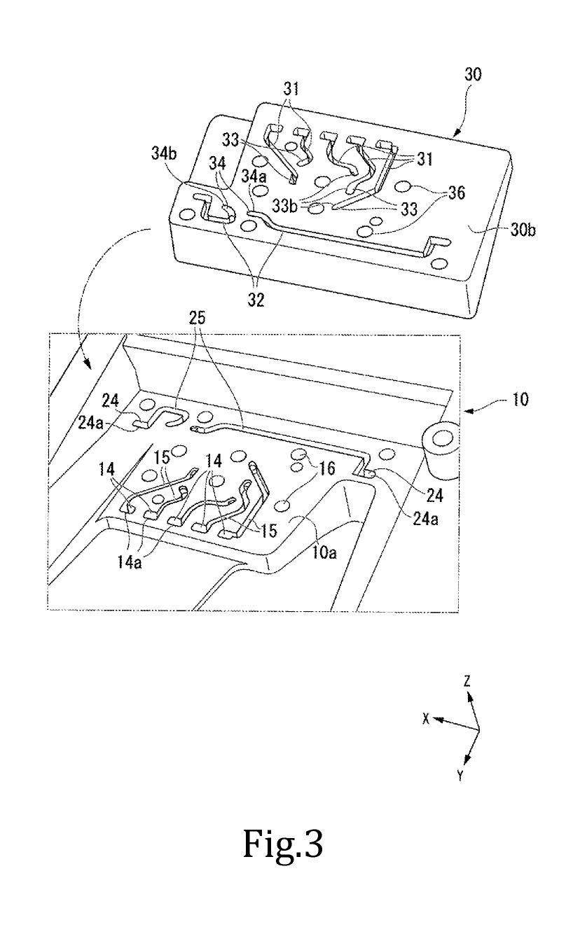

FIG. 3 shows a perspective view illustrating a state of the antenna member 10 and the feed member 30 before assembly. In FIG. 3, the feed member 30 is turned upside down for the convenience of explanation, with the lower surface 30b of the member facing upward.

A plurality of screw holes 16 used to fix the feed member 30 and the radar control board 40 is provided in the upper surface 10a of the antenna member 10.

In addition, first-type lower grooves 15 continuous from the openings 14a of the first-type lower holes 14 and second-type lower grooves 25 continuous from the openings 24a of the second-type lower holes 24 are provided in the upper surface 10a of the antenna member 10. Five first-type lower grooves 15 are provided in respective correspondence with the first-type lower holes 14, whereas two second-type lower grooves 25 are provided in respective correspondence with the second-type lower holes 24.

The first-type lower grooves 15 constitute parts of the first-type waveguides 8 along with the first-type upper grooves 31 of the feed member 30 to be described later. Likewise, the second-type lower grooves 25 constitute parts of the second-type waveguides 9 along with the second-type upper grooves 32 of the feed member 30.

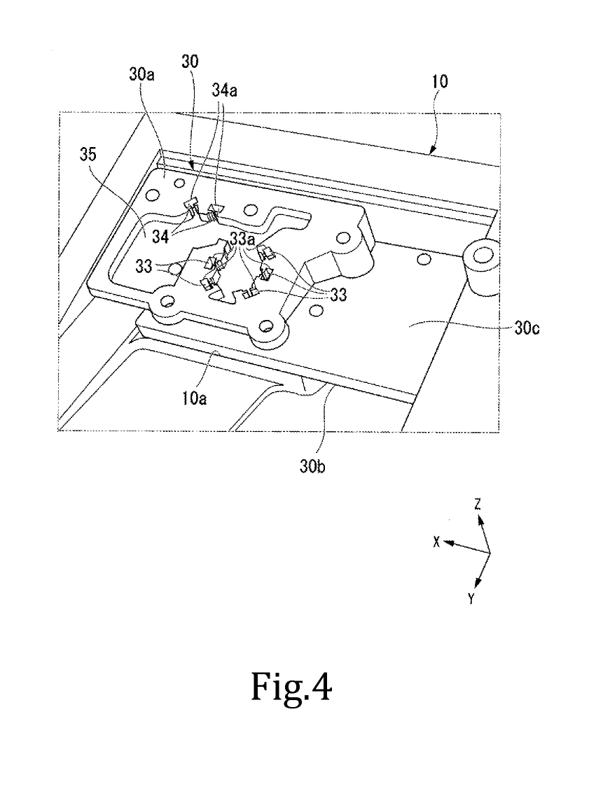

FIG. 4 shows a perspective view illustrating a state after the feed member 30 is assembled into the antenna member 10.

As illustrated in FIGS. 2 to 4, the feed member 30 is fitted on the upper surface 10a at the rear of the antenna member 10. The feed member 30 has a block-like shape and is preferably made of an aluminum alloy. The feed member 30 can be manufactured by means of die-casting or cutting work. The feed member 30 includes a lower surface (feed member-side contact surface) 30b (see FIG. 3) positioned on the lower side of the feed member and an upper surface 30a and a lower-order upper surface 30c (see FIG. 4) positioned on the upper side of the feed member. As illustrated in FIG. 2, the upper surface 30a and the lower surface 30b are not parallel to each other, i.e., the upper surface 30a is inclined forward when the lower surface 30b is held horizontally.

A plurality of fixing holes 36 penetrating from the upper surface 30a to the lower surface 30b and used to fix the feed member is provided in the feed member 30.

In addition, five first-type upper holes 33 and two second-type upper holes 34 are provided in the feed member 30. The first-type upper holes 33 and the second-type upper holes 34 penetrate through the upper surface 30a and the lower surface 30b of the feed member 30. The first-type upper holes 33 and the second-type upper holes 34 are arranged vertically to the upper surface 30a.

As illustrated in FIG. 3, the first-type upper grooves 31 extending from the openings 33b of the first-type upper holes and the second-type upper grooves 32 extending from the openings 34b of the second-type upper holes 34 are provided in the lower surface 30b of the feed member 30.

The feed member 30 abuts on the upper surface 10a of the antenna member 10 on the lower surface 30b. The first-type lower grooves 15 provided in the upper surface 10a of the antenna member 10 face the first-type upper grooves 31 provided in the lower surface 30b of the feed member 30. The first-type lower grooves 15 and the first-type upper grooves 31 are shaped to be reflectively symmetrical to each other. As illustrated in FIG. 2, the first-type lower grooves 15 and the first-type upper grooves 31 lie on top of each other while facing each other, thus constituting tunnel-like first-type relay holes 6 in the boundary between the feed member 30 and the antenna member 10.

Likewise, the second-type lower grooves 25 and the second-type upper grooves 32 are shaped to be reflectively symmetrical to each other. The second-type lower grooves 25 and the second-type upper grooves 32 lie on top of each other while facing each other, thus constituting second-type relay holes 7.

As illustrated in FIG. 4, the feed member 30 includes an upper surface 30a, and a lower-order upper surface 30c provided one step lower than the upper surface 30a.

The openings 33a of the first-type upper holes 33 and the openings 34a of the second-type upper holes 34 are positioned on the upper surface 30a of the feed member 30. In addition, a concave portion 35 is provided on the upper surface 30a of the feed member 30. The concave portion 35 is continuous to the openings 33a and the openings 34a. The concave portion 35 is substantially similar in shape to a radio frequency circuit region 45 of the radar control board 40 to be described later, though slightly larger than the board.

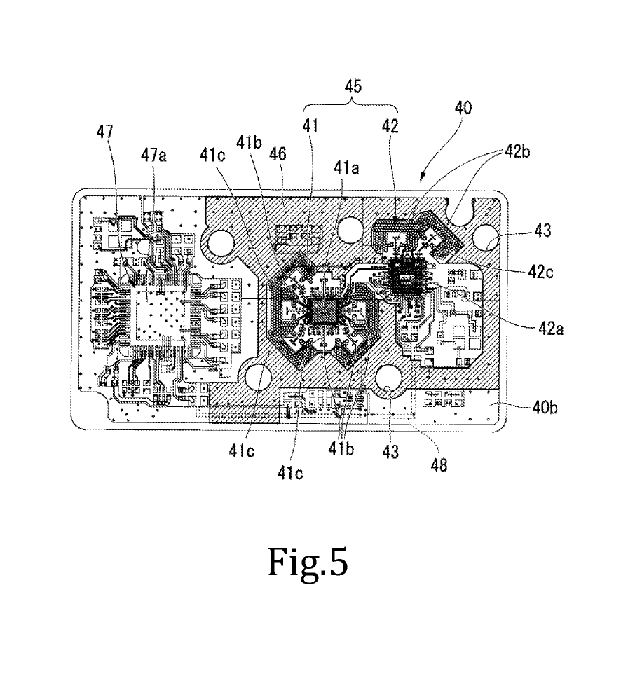

FIG. 5 illustrates a plan view when the radar control board 40 is viewed from the lower surface side 40b thereof.

The radar control board 40 is fixed on the upper surface 30a of the feed member 30. Consequently, the surface of the radar control board 40 is arranged so as to extend in a direction in which the first-type horns 11 and the second-type horns 21 extend and in the width direction thereof. A plurality of fixing holes 43 used to fix the radar control board 40 is provided in the board. The radar control board 40 and the feed member 30 are fixed by inserting screws (not illustrated) made to penetrate through the fixing holes 43 of the radar control board 40 and the fixing holes 36 of the feed member 30 into the screw holes 16 of the antenna member 10.

In the present preferred embodiment, the radar control board 40 is disposed on the upper side of the antenna member 10. The radar control board 40 may be disposed on the lower side of the antenna member 10, however. In this case, the radar control board 40 may be further covered with a cover from below.

As illustrated in FIG. 5, the first-type radio frequency circuit 41 for receiving radar waves, the second-type radio frequency circuit 42 for transmitting radar waves, and an information-processing circuit 47 are mounted on the radar control board 40. In the radar control board 40, the planar position of the information-processing circuit 47 does not overlap with the planar positions of the first-type radio frequency circuit 41 and the second-type radio frequency circuit 42.

In addition, a signal line 48 for connecting the first-type radio frequency circuit 41 and the second-type radio frequency circuit 42 to the information-processing circuit 47 is provided on the radar control board 40.

The information-processing circuit 47 includes an information-processing integrated circuit 47a. The information-processing integrated circuit 47a plays the role of controlling the first-type radio frequency circuit 41 and the second-type radio frequency circuit 42 and processing information. More specifically, the information-processing integrated circuit 47a instructs the second-type radio frequency circuit 42, through the signal line 48, to transmit radar waves. In addition, the information-processing integrated circuit 47a performs computations on information in received radar waves obtained from the first-type radio frequency circuit 41 through the signal line 48 to estimate the distance to an object, the direction of the object, and the like.

As the result of the radar control board 40 being assembled into the feed member 30, the lower surface 40b of the board abuts on the upper surface 30a of the feed member 30. In addition, a region, among the regions of the lower surface 40b, where the information-processing circuit 47 is configured is arranged oppositely to the lower-order upper surface 30c of the feed member 30.

The first-type radio frequency circuit 41 and the second-type radio frequency circuit 42 are disposed adjacently to each other and, as a whole, constitute a radio frequency circuit region 45. A closed foil 46 (the hatched region of FIG. 5) made of conductive material and surrounding the radio frequency circuit region 45 (i.e., the first-type radio frequency circuit 41 and the second-type radio frequency circuit 42) is provided on the lower surface 40b of the radar control board 40.

The foil 46 is made of, for example, copper. The foil plays the role of shielding against electromagnetic fields generated by the radio frequency circuit region 45 disposed on the inner side of the lower surface 40b.

The foil 46 is provided in a region of the lower surface 40b of the radar control board 40 where the foil 46 is in contact with the upper surface 30a of the feed member 30. As the result of making contact with the upper surface 30a of the feed member 30, the foil 46 is grounded through the feed member 30 to the antenna member 10 set at a reference potential.

The first-type radio frequency circuit 41 includes a radio frequency integrated circuit 41a, and five transmission channels (microstriplines) 41c extending from the radio frequency integrated circuit 41a and including receiving ends 41b at the leading ends of the channels.

Likewise, the second-type radio frequency circuit 42 includes a radio frequency integrated circuit 42a, and two transmission channels (microstriplines) 42c extending from the radio frequency integrated circuit 42a and including transmitting ends 42b at the leading ends of the channels.

As illustrated in FIG. 2, the receiving ends 41b of the first-type radio frequency circuit 41 are positioned above the openings 33a of the first-type upper holes 33 of the feed member 30. Electromagnetic waves propagating from the first-type upper holes 33 are received at the receiving ends 41b.

Likewise, the transmitting ends 42b of the second-type radio frequency circuit 42 are positioned above the openings 34a of the second-type upper holes 34 of the feed member 30. Electromagnetic waves from the radio frequency integrated circuit 42a are transmitted from the transmitting ends 42b to the second-type upper holes 34.

The radar control board (common board) 40 is, for example, a ceramic board or a glass epoxy board and is made of insulating material. The radar control board 40 is particularly preferably a glass epoxy board. This makes it possible to suppress the cost of the radar control board 40.

Next, a description will be made of the feed unit 5 including the first-type waveguides 8 and the second-type waveguides 9, which are the transmission paths of transmitted and received radar waves, and composed of the antenna member 10 and the feed member 30.

The feed unit 5 is composed of the feed member 30 including the upper surface 30a and the lower surface 30b and the antenna member 10 including the antenna member-side contact surface (upper surface) 10a. The feed unit 5 includes the five first-type waveguides 8 for guiding received radar waves and the two second-type waveguides 9 for guiding transmitted radar waves.

In addition, the feed unit 5 covers the first-type radio frequency circuit 41 and the second-type radio frequency circuit 42 on the upper surface 30a of the feed member 30.

The feed unit 5 includes the first-type lower holes 14 and the first-type lower grooves 15 of the antenna member 10, and the first-type upper grooves 31 and the first-type upper holes 33 of the feed member 30. These holes and grooves constitute the first-type waveguides 8.

The first-type lower grooves 15 and the first-type upper grooves 31 lie on top of each other while facing each other, thus constituting the first-type relay holes 6. One end of each first-type relay hole 6 is connected to a first-type lower hole 14, whereas the other end of each first-type relay hole 6 is connected to a first-type upper hole 33. Consequently, the first-type lower hole 14, the first-type relay hole 6 and the first-type upper hole 33 constitute a first-type waveguide 8 that is a train of holes.

Likewise, the feed unit 5 includes the second-type lower holes 24 and the second-type lower grooves 25 of the antenna member 10, and the second-type upper grooves 32 and the second-type upper holes 34 of the feed member 30. These holes and grooves constitute the second-type waveguides 9.

The second-type lower grooves 25 and the second-type upper grooves 32 lie on top of each other while facing each other, thus constituting the second-type relay holes 7. One end of each second-type relay hole 7 is connected to a second-type lower hole 24, whereas the other end of each second-type relay hole 7 is connected to a second-type upper hole 34. Consequently, the second-type lower hole 24, the second-type relay hole 7 and the second-type upper hole 34 constitute a second-type waveguide 9 that is a train of holes.

The first-type waveguides 8 and the second-type waveguides 9 are paths inclined forward in the first-type upper holes 33 and the second-type upper holes 34 provided in the feed member 30.

The first-type waveguides 8 each have one end connected to the respective base portions 12 of the first-type horns 11. In addition, the first-type waveguides 8 are open on different receiving ends 41b of the first-type radio frequency circuit 41 at the other end of each of the waveguides. The first-type waveguides 8 guide radar waves received by the first-type horns 11 to the receiving ends 41b.

The second-type waveguides 9 each have one end connected to the respective base portions 22 of the second-type horns 21. In addition, the second-type waveguides 9 are open on different transmitting ends 42b of the second-type radio frequency circuit 42 at the other end of each of the waveguides. The second-type waveguides 9 guide radar waves transmitted from the transmitting ends 42b to the base portions 22 of the second-type horns 21.

The feed unit 5 includes the first-type relay holes 6 of the first-type waveguides 8 and the second-type relay holes 7 of the second-type waveguides 9 between the antenna member 10 and the feed member 30. The first-type relay holes 6 and the second-type relay holes 7 are positioned on a plane (plane parallel to the X-Y plane) in a direction substantially orthogonal to the height direction Z direction) of the feed unit 5. Accordingly, the first-type relay holes 6 and the second-type relay holes 7 can be formed by elongating the first-type waveguides 8 and the second-type waveguides 9, respectively, in the width direction (X direction) and the length direction (Y direction). Consequently, the openings 33a of the first-type waveguides 8 and the openings 34a of the second-type waveguides 9 can be located properly, according to the configuration of the radar control board 40. That is, the receiving ends 41b of the first-type radio frequency circuit 41 and the transmitting ends 42b of the second-type radio frequency circuit 42 of the radar control board 40 can be simplified in configuration to achieve cost reductions.

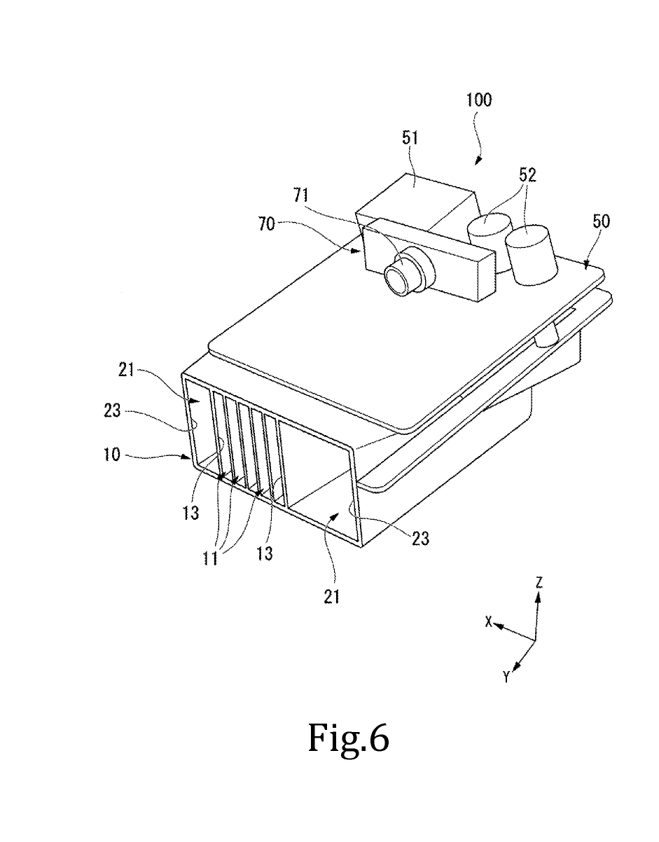

FIG. 6 shows a perspective view illustrating a state of the radar apparatus 100 in which the upper case 80 and the front cover 90 are removed.

As illustrated in FIGS. 2 and 6, the power-supply circuit board 50 is disposed above the radar control board 40 and substantially parallel to the radar control board 40. The power-supply circuit board 50 is screw-fixed to the antenna member 10.

The power-supply circuit board 50 is connected to the radar control board 40 and the imaging apparatus 70 through the wire 60 to supply DC power to the radar control board 40 and the imaging apparatus 70. In addition, the power-supply circuit board 50 is equipped with a control circuit for controlling the imaging apparatus 70. The power-supply circuit board 50 may also be equipped with a processing unit for issuing commands to the imaging apparatus 70 on the basis of information, such as the distance and direction of an object, arithmetically processed and derived by the radar control board 40.

A connector 51 to which external terminals are connected and capacitors 52 for maintaining a power supply voltage constant are mounted on the power-supply circuit board 50. The connector 51 and the capacitors 52 are comparatively tall among mounted components.

The capacitors 52 are bypass capacitors used to connect a power-supply line and the ground, in order to prevent a power supply voltage from fluctuating. The capacitors 52 are provided to prevent a voltage drop in a circuit when the circuit requires a large current. Accordingly, the capacitors 52 are large in size and height since the capacitors need to have electrical capacitance high enough to prevent voltage drops.

The connector 51 and the capacitors 52 are located in a backward position on the power-supply circuit board 50 and more backward than the imaging apparatus 70. As illustrated in FIG. 2, the radar apparatus 100 includes the antenna member 10 that is gradually reduced in height from before backward. Disposing the connector 51 and the capacitors 52 in the backward position on the power-supply circuit board 50 means that the tall connector 51 and capacitors 52 are located in an area where the antenna member 10 is low in profile. This configuration allows the height of the radar apparatus 100 to be averaged, thereby preventing the height from increasing locally.

The imaging apparatus 70 includes an imaging optical system 71, an image sensor 72, and a board 73. In addition, the imaging apparatus 70 is screw-fixed to the upper case 80.

The imaging optical system 71 faces forward and the optical axis thereof passes through a visual field window 81 of the upper case 80. The imaging optical system 71 is configured by, for example, combining a plurality of lenses the optical axes of which are aligned.

The image sensor 72 is disposed at the focal position of the imaging optical system 71. The image sensor 72 is a solid-state image sensor, such as a CCD image sensor or a CMOS image sensor, and captures subject images formed through the imaging optical system 71.

The image sensor 72 is mounted on the board 73. The board 73 is fixed together with the imaging optical system 71. In addition, the board 73 is connected to the power-supply circuit board 50 using a wire 60.

The imaging apparatus 70 is controlled by the control circuit of the power-supply circuit board 50 and supplied with power from the power-supply circuit board 50.

As illustrated in FIG. 1, the upper case 80 includes a rear upper surface 82 and a front upper surface 83 positioned on the upper side of the case, a pair of side surfaces 84 positioned on the lateral sides, and a rear surface 85 positioned on the back side.

The upper case 80 is screw-fixed together with the antenna member 10.

The upper case 80 includes an opening 87 on the front side thereof. The apertures 13 of the first-type horns 11 and the apertures 13 of the second-type horns 21 of the antenna member 10 are exposed forward from the opening 87. The front cover 90 is provided on the front side of the opening 87 to cover the apertures 13 and the apertures 23.

As illustrated in FIG. 2, the rear upper surface 82 is positioned one step above the front upper surface 83 with a step 86 therebetween. The imaging apparatus 70 and the connector 51 and the capacitors 52 mounted on the power-supply circuit board 50 are disposed below the rear upper surface 82.

The step 86 includes the visual field window 81 at the width-direction center of the step. The visual field window 81 is provided to secure the visual field of the imaging apparatus 70. A transparent plate may be fitted in the visual field window 81.

The front upper surface 83 is disposed so as to cover the downside of the visual field of the imaging apparatus 70, thereby blocking light traveling toward the imaging apparatus 70 from below the radar apparatus 100 and preventing the light from entering the imaging optical system 71.

The radar apparatus 100 of the present preferred embodiment may be installed in the interior space of an automobile in some cases. Specifically, the radar apparatus 100 may be located between a windshield and a rearview mirror in the interior of a vehicle with the front side of the apparatus directed at the windshield. If the radar apparatus 100 is too large in height (dimension in the Z-axis direction) in this case, the radar apparatus 100 may hinder the vision of a driver who drives the vehicle. If the radar apparatus 100 is too large in width (dimension in the X-axis direction) and length (dimension in the Y-axis direction), the radar apparatus 100 may be largely exposed from the back side of the rearview mirror, thus degrading designability.

Since all of the five first-type horns 11 and the two second-type horns 21 are lined up in the width direction of the apparatus, the radar apparatus 100 of the present preferred embodiment can suppress the height dimension. Accordingly, it is possible to prevent the radar apparatus 100 from hindering the vision of a driver when the radar apparatus 100 is installed in the interior space of a vehicle.

The upper surface 30a and the lower surface 30b of the feed member 30 of the radar apparatus 100 are not parallel to each other, and the upper surface 30a is inclined forward. As a result, the radar control board 40 fixed on the upper surface 30a of the feed member 30 is also inclined forward. That is, the surface of the radar control board 40 extends in the width and height directions of the first-type horns 11.

In the radar apparatus 100, the power-supply circuit board 50 is disposed above the radar control board 40. The radar control board 40 and the power-supply circuit board 50 are preferably disposed parallel to each other. Consequently, the radar apparatus 100 allows a certain gap to be provided between the radar control board 40 and the power-supply circuit board 50, thereby preventing the boards from mechanically interfering with each other.

The power-supply circuit board 50 is made parallel to the radar control board 40 and is therefore inclined forward along the radar control board 40. Consequently, the radar apparatus 100 allows the power-supply circuit board 50 to be disposed close to the antenna member 10 on the front side of the apparatus, thereby suppressing the front-side height dimension. In addition, in the radar apparatus 100, the front upper surface 83 of the upper case 80 is disposed along and parallel to the power-supply circuit board 50 to suppress the front-side height dimension of the radar apparatus 100 and cause the front upper surface 83 to be inclined forward. Consequently, the radar apparatus 100 allows the visual field of the imaging apparatus 70 to be broadened downward.

As a variation, a radar apparatus 200 will now be described.

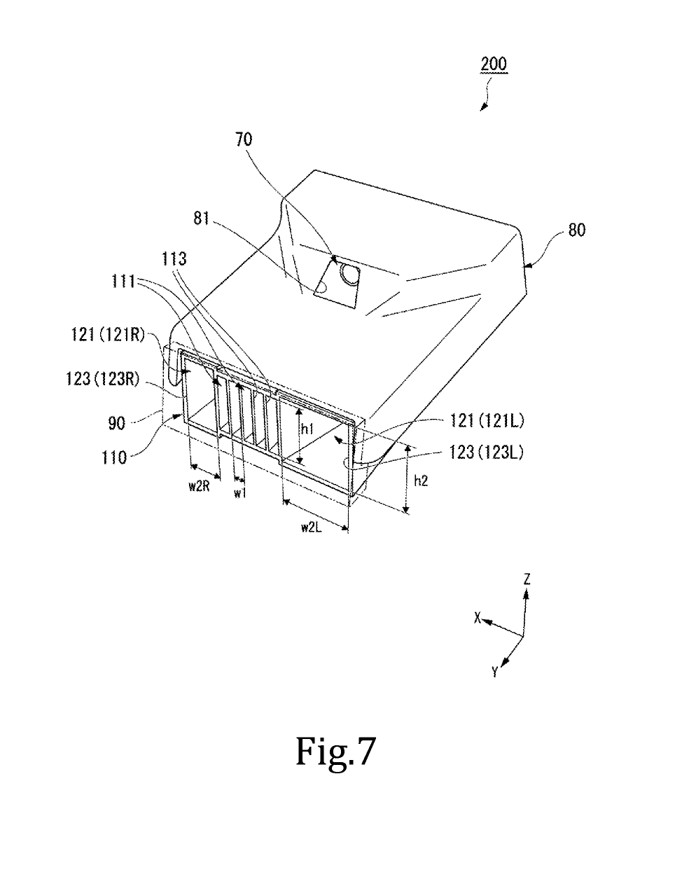

FIG. 7 shows a perspective view illustrating a radar apparatus 200 of the variation. The radar apparatus 200 differs from the radar apparatus 100 described above in the configuration of an antenna member 110. Note that the same constituent parts as those of the radar apparatus 100 described above are denoted by like reference numerals and characters and will not be described again. Also note that in FIG. 7, a front cover 90 is shown by a single-dot chain line for the sake of description of each constituent part.

The radar apparatus 200 includes the antenna member 110.

The antenna member 110 includes five first-type horns 111 lining up side by side in the width direction (X-axis direction) thereof and forming a row in the width direction; and two second-type horns 121 positioned at the leftmost and rightmost ends of the row of the first-type horns 111.

Each first-type horn 111 is a pyramidal horn and functions as part of an antenna for receiving radar waves.

The respective apertures 113 of the five first-type horns 111 are disposed on the same plane in the longitudinal direction of the horns. In addition, the apertures 113 of the five first-type horns 111 have the same shape. That is, the apertures 113 of the five first-type horns 111 have the same first-type height h1. In addition, the apertures 113 of the five first-type horns 111 have the same first-type width w1. Each aperture 113 has a vertically long rectangular transverse cross-sectional shape in which the first-type height h1 is greater than the first-type width w1.

Each second-type horn 121 is a pyramidal horn and functions as part of an antenna for transmitting radar waves.

The second-type horns 121 are positioned on the left and right of a row of the first-type horns 111. When the second-type horns 121 are described by distinguishing between the horns positioned on the left and right, the horn positioned on the right-hand side (+X side) of the row of the first-type horns 111 is referred to as a rightmost horn 121R, whereas the horn positioned on the left-hand side (−X side) is referred to as a leftmost horn 121L.

The aperture 123R of the rightmost horn 121R and the aperture 123L of the leftmost horn 121L have the same second-type height h2. The height h2 of the apertures 123 of the second-type horns 121 is greater than the first-type height h1 of the apertures 113 of the first-type horns 111.

In addition, the width w2R of the aperture 123R of the rightmost horn 121R is smaller than the width w2L of the aperture 123L of the leftmost horn 121L.

The aperture 123R of the rightmost horn 121R has a vertically long rectangular transverse cross-sectional shape whose height h2 is greater than the width w2R. On the other hand, the aperture 123L of the leftmost horn 121L has a transverse cross-sectional shape close to a square whose height h2 is substantially the same as the width w2L.

In the radar apparatus 200 of the variation, all of the apertures 113 of the first-type horns 111 have an identical height, i.e., the first-type height h1. In addition, all of the heights h2 of the apertures 123 of the second-type horns 121 are greater than the first-type height h1. Yet additionally, the height-direction center of the first-type horns 111 and the height-direction center of the second-type horns 121 substantially agree with each other.

The radar apparatus 200 includes two second-type horns 121. All of the apertures 113 of the first-type horns 111 have an identical height, i.e., the first height h1. In addition, all of the dimensions in the height direction (the heights h2) of the apertures 123 of the second-type horns 121 are greater than the first height h1.

The above-described configuration allows the radar apparatus 200 to reduce sidelobes in a product of the gains of a transmitting antenna and a receiving antenna.

More preferably, the radar apparatus 200 is such that the first-type horns 111 are disposed at the height-direction center of the second-type horns 121 to further facilitate the removal of sidelobes in the second-type horns 121.

Having thus described various preferred embodiments of the present invention, constituent parts, combinations thereof, and the like in each preferred embodiment are illustrative only. Accordingly, configurational additions, omissions, substitutions, and other modifications are possible without departing from the gist of the present invention.

For example, a radar apparatus provided with five first-type horns has been cited by way of example in each preferred embodiment. The preferred embodiments are not limited to this radar apparatus, however. Preferably, the radar apparatus is provided with three or more first-type horns.

In addition, a radar apparatus in which one each of second-type horns is disposed on the left and right of a row of first-type horns has been cited by way of example in each preferred embodiment. At least one second-type horn may be positioned at the leftmost or rightmost end of the row of first-type horns, however. For example, two second-type horns may be disposed at the rightmost end of the row. Alternatively, each preferred embodiment may be provided with at least one second-type horn, and therefore, the number of horns does not matter.

Yet additionally, in each preferred embodiment, the apertures of two second-type horns are level with each other. The apertures of a plurality of second-type horns may differ in height, however.

Still additionally, in each preferred embodiment, an antenna member is provided with first-type horns and second-type horns. The antenna member is, however, not limited to an antenna of this type. Any antenna can be used as the antenna member as long as it is a directional antenna, and it may be, for example, an array antenna.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A radar apparatus comprising:
an antenna member capable of emitting or receiving microwaves;
a feed unit including a plurality of waveguides each having one end connected to a base portion of the antenna member;
a radio frequency circuit in contact with the feed unit;
an information-processing circuit;
a signal line connecting the radio frequency circuit and the information-processing circuit; and
a common board equipped with the radio frequency circuit and the information-processing circuit; wherein
planar positions of the information-processing circuit and the radio frequency circuit on the common board do not overlap with each other;
the common board includes a closed foil made of conductive material and surrounding the radio frequency circuit; and
the closed foil made of conductive material is grounded.

2. The radar apparatus of claim 1, wherein
the radar apparatus includes a feed member that is a block-shaped or plate-like member including holes or grooves;
the feed member is in contact with the antenna member on a feed member-side contact surface thereof;
the antenna member is in contact with the feed member on an antenna member-side contact surface thereof;
the feed member includes holes or grooves provided in the feed member-side contact surface;
the antenna member includes holes or grooves provided in the antenna member-side contact surface;
the feed unit includes the feed member and the antenna member including the antenna member-side contact surface; and
the holes and grooves provided in the feed member-side contact surface and the holes and grooves provided in the antenna member-side contact surface constitute the waveguides of the feed unit.

3. The radar apparatus of claim 1, wherein
the common board is a glass epoxy board.

4. The radar apparatus of claim 2, wherein
the common board is a glass epoxy board.

5. The radar apparatus of claim 1, wherein
the antenna member includes a first-type horn and at least one second-type horn that are pyramidal horns each having an aperture and a base portion, the apertures of the first-type horns having a height greater than a width thereof, a length from a base portion to an aperture of the first-type horn being a first-type length, a length from a base portion to an aperture of the at least one second-type horn being a second length and greater than the first-type length;
at least three first-type horns are present in the antenna member;
the waveguides connected to the respective base portions of the first-type horns are open on different receiving ends on the radio frequency circuit at another end of each waveguide;
the first-type horns and the at least one second-type horn are directed generally a same direction which is defined to be a forward direction;
the at least three first-type horns line up side by side in a width direction thereof to form a row in the width direction;
at least one of the at least one second-type horn is positioned at a leftmost or rightmost end of the row of the first-type horns;
the waveguide connected to the base portion of the at least one second-type horn is open on a transmitting end on the radio frequency circuit at another end of the waveguide;
a positional difference between the apertures of the first-type horns and the at least one second-type horn in an longitudinal direction of the antenna member is smaller than a free space wavelength of a radio frequency electromagnetic wave output by the radio frequency circuit;
the base portion of the at least one second-type horn is positioned more backward than the base portions of the first-type horns by as much as a distance greater than the free space wavelength of the radio frequency wave output by the radio frequency circuit; and
at least part of the feed unit is positioned more forward than the base portion of the at least one second-type horn.

6. The radar apparatus of claim 2, wherein
the antenna member includes a first-type horn and at least one second-type horn that are pyramidal horns each having an aperture and a base portion, the apertures of the first-type horns having a height greater than a width thereof, a length from a base portion to an aperture of the first-type horn being a first-type length, a length from a base portion to an aperture of the at least one second-type horn being a second length and greater than the first-type length;
at least three first-type horns are present in the antenna member;
the waveguides connected to the respective base portions of the first-type horns are open on different receiving ends on the radio frequency circuit at another end of each waveguide;
the first-type horns and the at least one second-type horn are directed generally a same direction which is defined to be a forward direction;
the at least three first-type horns line up side by side in a width direction thereof to form a row in the width direction;
at least one of the at least one second-type horn is positioned at a leftmost or rightmost end of the row of the first-type horns;
the waveguide connected to the base portion of the at least one second-type horn is open on a transmitting end on the radio frequency circuit at another end of the waveguide;
a positional difference between the apertures of the first-type horns and the at least one second-type horn in an longitudinal direction of the antenna member is smaller than a free space wavelength of a radio frequency electromagnetic wave output by the radio frequency circuit;
the base portion of the at least one second-type horn is positioned more backward than the base portions of the first-type horns by as much as a distance greater than the free space wavelength of the radio frequency wave output by the radio frequency circuit; and
at least part of the feed unit is positioned more forward than the base portion of the at least one second-type horn.

7. The radar apparatus of claim 4, wherein
the antenna member includes a first-type horn and at least one second-type horn that are pyramidal horns each having an aperture and a base portion, the apertures of the first-type horns having a height greater than a width thereof, a length from a base portion to an aperture of the first-type horn being a first-type length, a length from a base portion to an aperture of the at least one second-type horn being a second length and greater than the first-type length;
at least three first-type horns are present in the antenna member;
the waveguides connected to the respective base portions of the first-type horns are open on different receiving ends on the radio frequency circuit at another end of each waveguide;
the first-type horns and the at least one second-type horn are directed generally a same direction which is defined to be a forward direction;
the at least three first-type horns line up side by side in a width direction thereof to form a row in the width direction;
at least one of the at least one second-type horn is positioned at a leftmost or rightmost end of the row of the first-type horns;
the waveguide connected to the base portion of the at least one second-type horn is open on a transmitting end on the radio frequency circuit at another end of the waveguide;
a positional difference between the apertures of the first-type horns and the at least one second-type horn in an longitudinal direction of the antenna member is smaller than a free space wavelength of a radio frequency electromagnetic wave output by the radio frequency circuit;
the base portion of the at least one second-type horn is positioned more backward than the base portions of the first-type horns by as much as a distance greater than the free space wavelength of the radio frequency wave output by the radio frequency circuit; and
at least part of the feed unit is positioned more forward than the base portion of the at least one second-type horn.

8. The radar apparatus of claim 7, wherein
the common board is positioned on an upper or lower side of the antenna member.

9. The radar apparatus of claim 5, wherein
a number of the first-type horns is five; and
the five first-type horns line up side by side in a width direction thereof to form a row in the width direction.

10. The radar apparatus of claim 6, wherein
a number of the first-type horns is five; and
the five first-type horns line up side by side in a width direction thereof to form a row in the width direction.

11. The radar apparatus of claim 7, wherein
a number of the first-type horns is five; and
the five first-type horns line up side by side in a width direction thereof to form a row in the width direction.

12. The radar apparatus of claim 8, wherein
a number of the first-type horns is five; and
the five first-type horns line up side by side in a width direction thereof to form a row in the width direction.

13. The radar apparatus of claim 5, wherein
a number of the at least one second-type horn is two;
all of the apertures of the first-type horns have an identical first height, and
all of the apertures of the second-type horns have a height greater than the first height.

14. The radar apparatus of claim 6, wherein
a number of the at least one second-type horn is two;
all of the apertures of the first-type horns have an identical first height, and
all of the apertures of the second-type horns have a height greater than the first height.

15. The radar apparatus of claim 7, wherein
a number of the at least one second-type horn is two;
all of the apertures of the first-type horns have an identical first height, and
all of the apertures of the second-type horns have a height greater than the first height.

16. The radar apparatus of claim 8, wherein
a number of the at least one second-type horn is two;
all of the apertures of the first-type horns have an identical first height, and
all of the apertures of the second-type horns have a height greater than the first height.

17. The radar apparatus of claim 9, wherein
a number of the at least one second-type horn is two;
all of the apertures of the first-type horns have an identical first height, and
all of the apertures of the second-type horns have a height greater than the first height.

18. The radar apparatus of claim 10, wherein
a number of the at least one second-type horn is two;
all of the apertures of the first-type horns have an identical first height, and
all of the apertures of the second-type horns have a height greater than the first height.

19. The radar apparatus of claim 11, wherein
a number of the at least one second-type horn is two;
all of the apertures of the first-type horns have an identical first height, and
all of the apertures of the second-type horns have a height greater than the first height.

20. The radar apparatus of claim 12, wherein
a number of the at least one second-type horn is two;
all of the apertures of the first-type horns have an identical first height, and
all of the apertures of the second-type horns have a height greater than the first height.
